(19) United States
(12) Patent Application Publication
(10) Pub. No.: US 2025/0278109 A1
(43) Pub. Date: Sep. 4, 2025

(54) DATA PROCESSING APPARATUS AND METHOD, AND STORAGE MEDIUM

(71) Applicant: TENCENT TECHNOLOGY (SHENZHEN) COMPANY LIMITED, Shenzhen (CN)

(72) Inventor: Zimu REN, Shenzhen (CN)

(21) Appl. No.: 19/211,702

(22) Filed: May 19, 2025

Related U.S. Application Data
(63) Continuation of application No. PCT/CN2023/133224, filed on Nov. 22, 2023.

(30) Foreign Application Priority Data
Apr. 14, 2023 (CN) 202310429108.1

(51) Int. Cl. G06F 1/04

(52) U.S. Cl. CPC G06F 1/04

(57) ABSTRACT

A data processing apparatus is provided with a systolic array configured to perform a feature operation on feature data obtained from feature extraction on service data of a target service. The feature data includes n pieces of feature subdata arranged in sequence. The systolic array includes a feature operation module including n groups of feature operation units configured to perform the feature operation on the n pieces of feature subdata. The n groups of feature operation units are connected according to association operation logic between the n pieces of feature subdata. A group of feature operation units includes a first operation subunit and a second operation subunit that are connected according to feature operation logic of a corresponding feature subdata. The n groups of feature operation units perform the feature operation on the n pieces of feature subdata in a preset sequence corresponding to the association operation logic.

### CROSS-REFERENCES TO RELATED APPLICATIONS

This application is a continuation application of PCT Patent Application No. PCT/CN2023/133224, filed on Nov. 22, 2023, which claims priority to Chinese Patent Application No. 202310429108.1, filed on Apr. 14, 2023, all of which is incorporated by reference in their entirety.

### FIELD OF THE TECHNOLOGY

The present disclosure relates to the field of computer technologies and, in particular, relates to, a data processing apparatus and method, an artificial intelligence (AI) processor, a computer-readable storage medium, and a computer program product.

### BACKGROUND OF THE DISCLOSURE

With rapid development of computer technologies, the computing power requirements of artificial intelligence (AI) processors in the field of artificial intelligence technology are gradually increasing. AI processors may alternatively be referred to as AI chips. The AI processors need to process a large quantity of data operations in the field of AI technologies. A systolic array is a key operation component of the AI processor. Specifications of the systolic array directly determine peak computing power of the AI processor, and are the key technical indicator of the AI processor.

Currently, a data operation process of the systolic array usually causes a large delay, which affects data operation efficiency of the systolic array. Therefore, how to reduce the data operation delay of the systolic array and improve the data operation efficiency of the systolic array has become a current research hotspot.

### SUMMARY

One embodiment of the present disclosure provides a data processing apparatus. The data processing apparatus is provided with a systolic array configured to perform a feature operation on feature data obtained from feature extraction on service data of a target service. The feature data includes n pieces of feature subdata arranged in sequence, n being an integer greater than or equal to 1. The systolic array includes a feature operation module, the feature operation module including n groups of feature operation units, the n groups of feature operation units being configured to perform the feature operation on the n pieces of feature subdata in the feature data, and the n groups of feature operation units being connected according to association operation logic between the n pieces of feature subdata. A group of feature operation units includes a first operation subunit and a second operation subunit, and the first operation subunit and the second operation subunit are connected according to feature operation logic of the corresponding feature subdata. The n groups of feature operation units perform the feature operation on the n pieces of feature subdata in a preset sequence corresponding to the association operation logic, and in the preset sequence, in any two adjacent groups of feature operation units, a time at which a first group of feature operation units starts the feature operation is at least one preset clock cycle earlier than a time at which a second group of feature operation units starts the feature operation.

Another embodiment of the present disclosure provides a data processing method, applied to a data processing apparatus provided with a systolic array including a feature operation module that includes n groups of feature operation units, and n being an integer greater than or equal to 1. The method includes receiving feature data, the feature data being obtained by performing feature extraction on service data of a target service, and the feature data including n pieces of feature subdata arranged in sequence; and invoking the n groups of feature operation units to perform a feature operation on the n pieces of feature subdata in a preset sequence, the n groups of feature operation units being configured to perform the feature operation on the n pieces of feature subdata in the feature data, the n groups of feature operation units being connected according to association operation logic between the n pieces of feature subdata, a group of feature operation units including a first operation subunit and a second operation subunit, and the first operation subunit and the second operation subunit being connected according to feature operation logic of the corresponding feature subdata, and in the preset sequence, in any two adjacent groups of feature operation units, a time at which a first group of feature operation units starts the feature operation is at least one preset clock cycle earlier than a time at which a second group of feature operation units starts the feature operation.

Another embodiment of the present disclosure provides a non-transitory computer-readable storage medium containing a computer program that, when being executed, causes an Artificial Intelligence (AI) processor to perform a data processing method applied to a data processing apparatus provided with a systolic array including a feature operation module that includes n groups of feature operation units, and n being an integer greater than or equal to 1. The method includes receiving feature data, the feature data being obtained by performing feature extraction on service data of a target service, and the feature data including n pieces of feature subdata arranged in sequence; and invoking the n groups of feature operation units to perform a feature operation on the n pieces of feature subdata in a preset sequence, the n groups of feature operation units being configured to perform the feature operation on the n pieces of feature subdata in the feature data, the n groups of feature operation units being connected according to association operation logic between the n pieces of feature subdata, a group of feature operation units including a first operation subunit and a second operation subunit, and the first operation subunit and the second operation subunit being connected according to feature operation logic of the corresponding feature subdata, and in the preset sequence, in any two adjacent groups of feature operation units, a time at which a first group of feature operation units starts the feature operation is at least one preset clock cycle earlier than a time at which a second group of feature operation units starts the feature operation.

### BRIEF DESCRIPTION OF THE DRAWINGS

To describe technical solutions in embodiments of the present disclosure more clearly, the following briefly introduces accompanying drawings for describing various embodiments. Apparently, the accompanying drawings in the following description show merely some embodiments of the present disclosure, and a person of ordinary skill in the art may still derive other drawings from the accompanying drawings without creative efforts, which is encompassed within the scope of present disclosure.

FIG. 1 is a schematic structural diagram of a systolic array according to an embodiment of the present disclosure.

FIG. 2 is a schematic structural diagram of a systolic array according to an embodiment of the present disclosure.

FIG. 3 is a schematic structural diagram of a feature operation unit according to an embodiment of the present disclosure.

FIG. 4 is a schematic diagram of an alignment shift operation according to an embodiment of the present disclosure.

FIG. 5 is a schematic structural diagram of another existing systolic array according to an embodiment of the present disclosure.

FIG. 6 is a schematic diagram of a normalized shift operation according to an embodiment of the present disclosure.

FIG. 7 is a schematic diagram of clock cycle control according to an embodiment of the present disclosure.

FIG. 8 is a schematic flowchart of a data processing method according to an embodiment of the present disclosure.

### DESCRIPTION OF EMBODIMENTS

Technical solutions in the embodiments of the present disclosure will be clearly and completely described below with reference to the accompanying drawings in the embodiments of the present disclosure. Apparently, the described embodiments are merely part rather than all embodiments of the present disclosure. All other embodiments obtained by a person of ordinary skill in the art based on the embodiments of the present disclosure without making creative efforts shall fall within the protection scope of the present disclosure.

Embodiments of the present disclosure provide a data processing apparatus and method, an artificial intelligent processor, a computer-readable storage medium, and a computer program product, which can reduce a data operation delay of a systolic array, and improve data operation efficiency of the systolic array.

AI involves a theory, a method, a technology, and an application system that use a digital computer or a machine controlled by the digital computer to simulate, extend, and expand human intelligence, perceive an environment, obtain knowledge, and use knowledge to obtain an optimal result. In other words, AI is a comprehensive technology in computer science and attempts to understand the essence of intelligence and produce a new intelligent machine that can react in a mode similar to human intelligence. AI is to study the design principles and implementation methods of various intelligent machines, to enable the machines to have the functions of perception, reasoning, and decision-making. An AI technology is a comprehensive discipline, and relates to a wide range of fields including both hardware-level technologies and software-level technologies. AI software technologies mainly include several major directions such as a computer vision (CV) technology, a voice processing technology, a natural language processing technology and machine learning/deep learning, autonomous driving, and smart transportation. Hardware AI technologies generally include technologies such as a sensor, a dedicated AI processor (or referred to as an AI chip), cloud computing, distributed storage, a big data processing technology, an operating/interaction system, and electromechanical integration.

An AI processor in the artificial intelligence hardware technology may alternatively be referred to as an AI chip, and may be configured to perform a data operation on relevant data related to the AI field (or may be referred to as an AI service). In more detail, the AI processor may be configured to perform a feature operation on feature data. The feature data may be obtained by performing feature extraction on service data involved in a target service (for example, an AI service). The AI service may include, but is not limited to, any one of the following: an image processing service, a voice processing service, a natural language processing service, and the like. That is, the feature data may be obtained by performing feature extraction on image data involved in the image processing service, the feature data may be obtained by performing feature extraction on voice data involved in the voice processing service, the feature data may be obtained by performing feature extraction on natural language text data involved in the natural language processing service, or the like. Data forms of the feature data may be diversified, and the data forms of the feature data may include, but are not limited to, any one of the following: feature map data, a feature vector, a feature value, and the like. A data form of the feature data is not limited in this embodiment of the present disclosure. The feature operation performed on the feature data may include a convolution operation or a matrix operation.

The systolic array is a key operation component of the AI processor. The AI processor may perform the feature operation on the feature data by using the systolic array. That is, the systolic array in the AI processor may be configured to perform the feature operation on the feature data. The systolic array refers to an array in which data flows between internal processing units and the internal processing units process the data that flows through. A pulsating direction of the systolic array determines a dimension of the systolic array. For example, a systolic array having one pulsating direction is a one-dimensional systolic array, a systolic array having two pulsating directions is a two-dimensional systolic array, and a systolic array having three pulsating directions is a three-dimensional systolic array. The dimension of the systolic array is not limited in this embodiment of the present disclosure. Using a two-dimensional systolic array as an example, pulsation directions of the two-dimensional systolic array may include a horizontal pulsation and a longitudinal pulsation, data flowing in the horizontal pulsation is usually feature data, and data flowing in the longitudinal pulsation is usually weight data.

As a key operation component of the AI processor, a specification of the systolic array directly determines peak computing power of the AI processor, and is a key technical indicator of the AI processor. Currently, a data operation process of the systolic array usually causes a relatively large delay, which affects data operation efficiency of the systolic array. Based on this, an embodiment of the present disclosure provides a data processing apparatus. The data processing apparatus properly controls a clock cycle of data pulsation in a systolic array, thereby reducing a data operation delay of the systolic array, and improving data operation efficiency of the systolic array. The clock cycle may be referred to as an oscillator cycle, is defined as a reciprocal of a clock frequency, and is a most basic and smallest time unit in a computer.

The following describes an overall structure of a data processing apparatus provided by the embodiments of the present disclosure with reference to accompanying drawings.

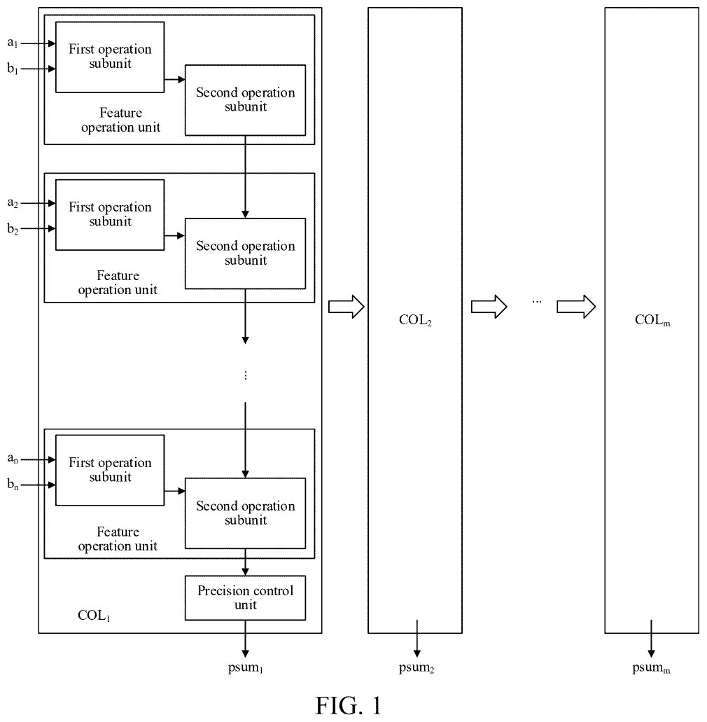

A systolic array may be provided in the data processing apparatus, and the systolic array may be configured to perform a feature operation on feature data to obtain a feature operation result of the feature data under the systolic array. As shown in FIG. 1, the systolic array may include m feature operation modules (as shown in FIG. 1, the m feature operation modules may be separately represented as COL1, . . . , COLm), and m is an integer greater than or equal to 1. An input of each of the m feature operation modules is feature data, and each of the m feature operation modules may separately perform a feature operation on the feature data to obtain feature operation results of the feature data under each of the m feature operation modules (as shown in FIG. 1, the feature operation results of the feature data under each of the m feature operation modules may respectively be represented by psum₁, . . . , psumₘ). The feature operation result of the feature data under the systolic array may be obtained by performing an accumulation operation on the feature operation results of the feature data under each of the m feature operation modules.

The feature data may be obtained by performing feature extraction on service data involved in a target service (including, but not limited to, an AI service). The feature data may include n pieces of feature subdata (as shown in FIG. 1, the n pieces of feature subdata may be represented as a₁, . . . , aₙ) sequentially arranged. Such sequential arrangement herein means that n pieces of feature subdata are arranged in sequence according to a sequence of feature operations. When a data form of the feature data is feature map data, the essence of the feature map data is a matrix, and the feature map data may include n rows of data arranged in sequence, that is, one row of data is one piece of feature subdata. When a data form of the feature data is a feature vector, the feature vector may include n dimensions of vectors arranged in sequence, that is, a vector of one dimension is one piece of feature subdata.

Structures of all of the m feature operation modules are the same, any feature operation module may include n groups of feature operation units, and n groups of feature operation units may be configured to perform a feature operation on a corresponding piece of feature subdata in the feature data to obtain a feature operation result of a group of feature operation units. Each of the n groups of feature operation units in the feature operation module includes a first operation subunit and a second operation subunit. In addition, each of the m feature operation modules corresponds to a weight set. Weight sets corresponding to the m feature operation modules may be the same or may be different. Any weight set may include n weights arranged in sequence (as shown in FIG. 1, the n weights may be represented as b₁, . . . , bₙ). Sequential arrangement herein means that n weights are arranged in sequence according to a sequence of feature operations. A group of feature operation units in any feature operation module corresponds to a weight in a corresponding weight set, and the weight may participate in a feature operation process performed by the feature operation unit on the feature subdata.

Any two adjacent feature operation units in the n groups of feature operation units are used as an example below to describe a connection relationship and a data flow direction between a first operation subunit and a second operation subunit that belong to the same group of feature operation units and a connection relationship and a data flow direction between the n groups of feature operation units:

Any two pieces of adjacently arranged feature subdata in the n pieces of feature subdata may be represented as an (i−1)^{th} piece of feature subdata and an i^{th} piece of feature subdata, where i is an integer greater than 1, and i is less than or equal to n. Any two adjacent groups of feature operation units in the n groups of feature operation units may be represented as an (i−1)^{th} group of feature operation units and an i^{th} group of feature operation units. The (i−1)^{th} group of feature operation units may be configured to perform a feature operation on the (i−1)^{th} piece of feature subdata. The i^{th} group of feature operation units may be configured to perform the feature operation on the i^{th} piece of feature subdata.

The n groups of feature operation units may be connected according to association operation logic between the n pieces of feature subdata. The association operation logic between the n pieces of feature subdata may include: a feature operation sequence of the (i−1)^{th} piece of feature subdata precedes the i^{th} piece of feature subdata, and a feature operation result of the (i−1)^{th} piece of feature subdata is applied to a feature operation process of the i^{th} piece of feature subdata. The (i−1)^{th} group of feature operation units is connected to the i^{th} group of feature operation units according to association operation logic between the n pieces of feature subdata. That is, an output end of the (i−1)^{th} group of feature operation units is connected to an input end of the i^{th} group of feature operation units according to the association operation logic between the n pieces of feature subdata.

The first operation subunit and the second operation subunit that belong to the same group of feature operation units may be connected according to feature operation logic of the corresponding feature subdata. The feature operation logic of the i^{th} piece of feature subdata may include: first operation processing is first performed on the i^{th} piece of feature subdata to obtain a feature operation result of the first operation processing, and then second operation processing is performed on the feature operation result of the first operation processing to obtain a feature operation result of the i^{th} group of feature operation units. That is, the feature operation result of the first operation processing is applied to a process of the second operation processing. An input end of the first operation subunit i in the i^{th} group of feature operation units may be configured to receive the i^{th} piece of feature subdata, and perform the first operation processing on the i^{th} piece of feature subdata. An output end of the first operation subunit i is connected to an input end of a second operation subunit i in the i^{th} group of feature operation units, and an input end of the second operation subunit i is configured to receive a first operation result of the first operation subunit i, and perform second operation processing on the first operation result to obtain the feature operation result of the i^{th} group of feature operation units.

Based on this, that the (i−1)^{th} group of feature operation units is connected to the i^{th} group of feature operation units may be that a second operation subunit i−1 in the (i−1)^{th} group of feature operation units is connected to a second operation subunit i in the i^{th} group of feature operation units, and an output end of the second operation subunit i−1 is connected to an input end of the second operation subunit i.

Any two adjacent feature operation units in the n groups of feature operation units are used as an example below to describe clock cycle control logic between the n groups of feature operation units: the n groups of feature operation units may perform the feature operation on the n pieces of feature subdata in a preset sequence corresponding to the association operation logic. The preset sequence herein may be a feature operation sequence between the n pieces of feature subdata, the n pieces of feature subdata are arranged in sequence according to a sequence of the feature operations, and the n groups of feature operation units sequentially perform the feature operation on the corresponding feature subdata according to the feature operation sequence of the n pieces of feature subdata. That is, the association operation logic determines a connection sequence of the n groups of feature operation units. After the n groups of feature operation units are connected according to the connection sequence, each group of feature operation units is configured to perform the feature operation on the corresponding piece of feature subdata. Therefore, when the feature operation is performed, the sequence of the feature operations performed by the n groups of feature operation units on the n pieces of feature subdata is the preset sequence. That the preset sequence corresponds to the association operation logic refers to that: the n groups of feature operation units are connected according to the association operation logic between the n pieces of feature subdata, and correspondingly, the n groups of feature operation units sequentially perform, according to a sequence after the n groups of feature operation units are connected, the feature operation on feature subdata corresponding to each feature operation unit. Using an (i−1)^{th} piece of feature subdata and an i^{th} piece of feature subdata as an example, a feature operation sequence of the (i−1)^{th} piece of feature subdata precedes a feature operation sequence of the i^{th} piece of feature subdata. That is, a feature operation process performed by the (i−1)^{th} group of feature operation units on the (i−1)^{th} piece of feature subdata is prior to a feature operation process performed by the i^{th} group of feature operation units on the i^{th} piece of feature subdata. Based on this, according to a preset sequence, beat processing may be performed between any two adjacent groups of feature operation units. The beat processing herein may be understood as that in any two adjacent groups of feature operation units, a time at which a first group (or a preceding group) of feature operation units starts the feature operation is at least one preset clock cycle earlier than a time at which a second group (or a succeeding group) of feature operation units starts the feature operation, that is, the time at which the first group of feature operation units starts the feature operation is at least one preset clock cycle earlier than the time at which the second group of feature operation units starts the feature operation. That is, the time at which the first group of feature operation units start to perform the feature operation on the corresponding feature subdata is earlier than the time at which the second group of feature operation units start to perform the feature operation on the corresponding feature subdata, and an interval between two times (that is, the time at which the first group of feature operation units start to perform the feature operation on the corresponding feature subdata and the time at which a second group of feature budget units start to perform the feature operation on the corresponding feature subdata) is at least one preset clock cycle.

Using an (i−1)^{th} group of feature operation units and an i^{th} group of feature operation units as an example, the data processing apparatus may further include a beater, the beater may control a feature operation process between the n groups of feature operation units through beat processing, and a time interval that the beater performs two rounds of consecutive beat processing is at least one preset clock cycle. The (i−1)^{th} group of feature operation units can be controlled to start the feature operation on the (i−1)^{th} piece of feature subdata when the beater performs a round of beat processing at a time Tᵢ₋₁, that is, the (i−1)^{th} group of feature operation units starts the feature operation on the (i−1)^{th} piece of feature subdata when the beater performs a round of beat processing at a time Tᵢ₋₁. The i^{th} group of feature operation units can be controlled to start the feature operation on the i^{th} piece of feature subdata when the beater performs, at a time Tᵢ, a next round of beat processing adjacent to the beat processing at the time Tᵢ₋₁, that is, the i^{th} group of feature operation units starts the feature operation on the i^{th} piece of feature subdata when the beater performs the next round of beat processing at a time Tᵢ. The time interval between the time Tᵢ₋₁ and the time Tᵢ is a time interval between the two rounds of consecutive beat processing performed by the beater.

Any two adjacent feature operation modules in the m feature operation modules are used as an example below to describe clock cycle control logic between the m feature operation modules: the m feature operation modules may perform the feature operation on the feature data in a preset sequence. The preset sequence herein may be set by a relevant designer (for example, a designer or a design program) of the systolic array. In the preset sequence, beat processing may be performed between any two adjacent feature operation modules. The beat processing herein may be understood as that in any two adjacent feature operation modules, the time at which the previous feature operation module starts the feature operation is at least one preset clock cycle earlier than a time at which a later feature operation module starts the feature operation. That is, the time at which the previous feature operation module starts the feature operation on the feature data is earlier than a time at which the later feature operation module starts the feature operation on the feature data. In addition, an interval between two times (that is, the time at which the previous feature operation module starts the feature operation on the feature data and a time at which the later feature operation module starts the feature operation on the feature data) is the at least one preset clock cycle. For example, any two adjacent feature operation modules in the m feature operation modules may be represented as a (j−1)^{th} feature operation module and a j^{th} feature operation module, where j is an integer greater than 1 and j is less than or equal to m. The beater in the data processing apparatus may control a feature operation process between the m feature operation modules through beat processing, and a time interval between two rounds of consecutive beat processing performed by the beater is at least one preset clock cycle. The (j−1)^{th} feature operation module is controlled to start the feature operation on the feature data when the beater performs a round of beat processing at a time Tⱼ₋₁. A j^{th} feature operation module is controlled to start the feature operation on the feature data when the beater performs a next round of beat processing at a time Tⱼ. The time interval between the time Tⱼ₋₁ and the time Tⱼ is the time interval between the two rounds of consecutive beat processing performed by the beater. It is to be noted that, the beater configured to control a clock cycle between the n groups of feature operation units and the beater configured to a clock cycle of the m feature operation modules may be the same beater, different beaters, or different beat units of the same beater. This is not limited in this embodiment of the present disclosure.

In addition, any feature operation module may further include a precision control unit (rounding). An input end of the precision control unit in any group of feature operation modules may be connected to an output end of a last group of feature operation units in a corresponding feature operation module, for example, may be connected to an output end of a second operation subunit in the last group of feature operation units. That is, the input end of the precision control unit in any group of feature operation modules may be connected to an output end of an nth group of feature operation units in a corresponding feature operation module, for example, may be connected to an output end of a second operation subunit n in the nth group of feature operation units. The rounding unit in any group of feature operation modules may be configured to perform rounding processing on a feature operation result of the nth group of feature operation units in the corresponding feature operation module to obtain a feature operation result of the feature data under the corresponding feature operation module. The precision control processing may be rounding processing. An approximate result of the feature operation result may be obtained after the rounding processing is performed on the feature operation result. That is, the feature operation result of the feature data under the corresponding feature operation module is the approximate result of the feature operation result of the nth group of feature operation units in the corresponding feature operation module. The rounding processing can reduce feature operation complexity to some extent and improve feature operation efficiency while ensuring a relatively small impact on feature operation precision.

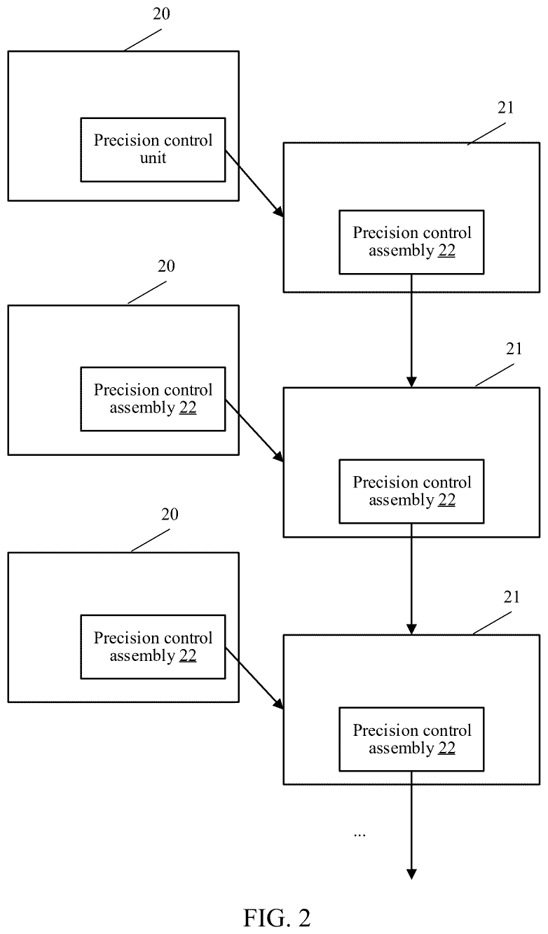

Based on the foregoing description of the overall structure of the data processing apparatus, it may be learned that: proper beat processing is performed between feature operation processes of the m feature operation modules and proper beat processing is performed between the n groups of feature operation units under the same feature operation module, thereby not only reducing a data operation delay of the systolic array, improving data operation efficiency of the systolic array, but also facilitating routing layout of the AI processor. In addition, the precision control processing reduces operation precision of the feature operation result to some extent. In this embodiment of the present disclosure, in any feature operation module, precision control processing is performed on only the feature operation result of the last group of feature operation units instead of an existing systolic array shown in FIG. 2. In the existing systolic array, a standard floating point multiplication unit (20) and a floating point addition unit (21) are invoked. Both the standard floating point multiplication unit (20) and the floating point addition unit (21) have a precision control assembly (22) therein, configured to perform a rounding operation. After calculation of each row of data is completed, a calculation result is transferred to a next column for a subsequent accumulation operation. In this way, a plurality of rounding operations are involved in an intermediate operation process of feature data. Therefore, compared with the existing systolic array shown in FIG. 2, the systolic array provided in this embodiment of the present disclosure can greatly improve feature operation precision of the feature data.

Based on the overall structure of the foregoing data processing apparatus, the following describes structures of the first operation subunit and the second operation subunit that belong to the same group of feature operation units. Using the first operation subunit i and the second operation subunit i in the i^{th} group of feature operation units as an example, feature operation logic of the i^{th} piece of feature subdata may include: first operation processing is first performed on the i^{th} piece of feature subdata, and then second operation processing is performed, and a feature operation result of the first operation processing may be applied to a process of the second operation processing. The first operation processing may include weighting operation processing, each group of feature operation units in the n groups of feature operation units may separately correspond to a weight, and a weight (which may be represented as an i^{th} weight) corresponding to the i^{th} group of feature operation units may be configured for the first operation subunit i in the i^{th} group of feature operation units to perform the weighting operation processing on the i^{th} piece of feature subdata to obtain a first operation result of the first operation subunit i. The second operation processing may include merging operation processing, and a second operation subunit i in the i^{th} group of feature operation units may be configured to perform merging operation processing on the first operation result of the first operation subunit i and a feature operation result of an (i−1)^{th} group of feature operation units to obtain a feature operation result of the i^{th} group of feature operation units. In this case, the first operation subunit may be represented as a multiply & exponent process unit (MEU), and the second operation subunit may be represented as an accumulate & shift process unit (ASU).

For a first operation subunit i (MEU[i]) in the i^{th} group of feature operation units, the first operation subunit i may be configured to perform weighting operation processing on the i^{th} piece of feature subdata according to the i^{th} weight to obtain the first operation result of the first operation subunit i. To simplify an operation, data may be decomposed into an exponent part (exp for short) and a mantissa part (man for short) for an operation. For example, the data may be represented as binary data 1.0010×2\hat{ }10, then 1.0010 is the mantissa part of the data, and 10 is the exponent part of the data. Multiplication between the data may be decomposed into an exponent operation between exponent parts and a mantissa operation between mantissa parts. That is, for the i^{th} piece of feature subdata and the i^{th} feature weight, the i^{th} piece of feature subdata ai may be decomposed into a feature exponent (exp_a [i]) and a feature mantissa (man_a [i]), and the i^{th} weight bi may be decomposed into a weight exponent (exp_b [i]) and a weight mantissa (man_b [i]). The weighting operation processing may be decomposed into an exponent operation and a mantissa operation.

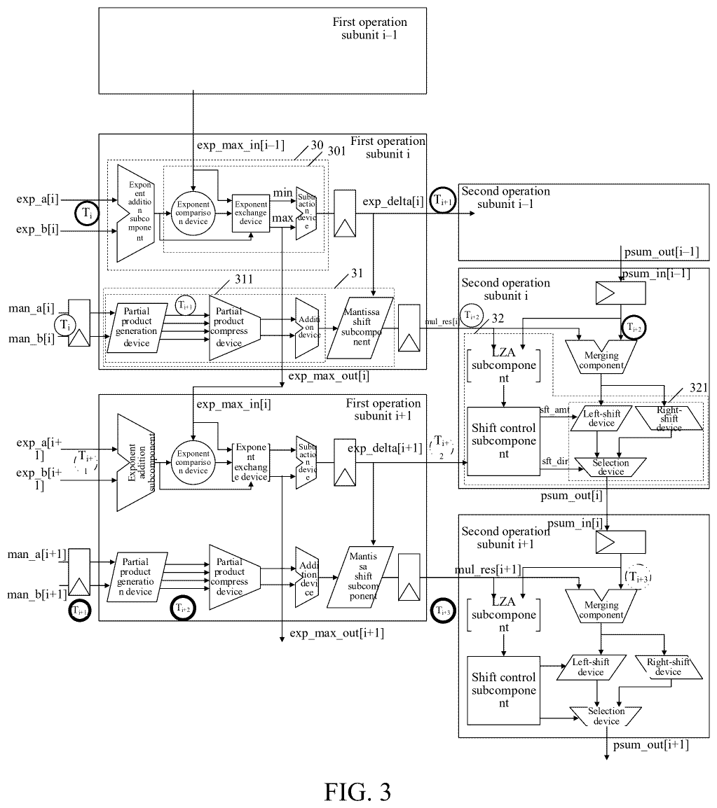

As shown in FIG. 3, the first operation subunit i may include an exponent operation component (30) and a mantissa operation component (31). For a connection relationship between the exponent operation component (30) and the mantissa operation component (31), refer to the following descriptions: an input end of the exponent operation component (30) may be configured to receive a feature exponent and a weight exponent, and an output end of the exponent operation component (30) is connected to the mantissa operation component (31) and a second operation subunit i−1 (ASU[i−1]); and an input end of the mantissa operation component (31) may be configured to receive a feature mantissa, a weight mantissa, and an exponent operation result of the exponent operation component (30), and an output end of the mantissa operation component (31) is connected to an input end of the second operation subunit i (ASU[i]). For operation logic between the exponent operation component (30) and the mantissa operation component (31), refer to the following descriptions: the exponent operation component (30) may be configured to perform an exponent operation on the feature exponent and the weight exponent, and output the exponent operation result of the exponent operation component (30) to the mantissa operation component (31) and the second operation subunit i−1; and the mantissa operation component (31) may be configured to perform a mantissa operation on the feature mantissa, the weight mantissa, and the exponent operation result of the exponent operation component (30) to obtain a first operation result (mul_res [i]) of the first operation subunit i.

For the exponent operation component (30): as shown in FIG. 3, the exponent operation component (30) may include an exponent addition subcomponent (add) and an exponent comparison subcomponent i (301). For a connection relationship between the exponent addition subcomponent and the exponent comparison subcomponent i (301), refer to the following descriptions: an input end of the exponent addition subcomponent may be configured to receive the feature exponent and the weight exponent; an input end of the exponent comparison subcomponent i (301) is connected to an output end of the exponent addition subcomponent and an output end of the exponent comparison subcomponent i−1. The exponent comparison subcomponent i−1 is an exponent comparison subcomponent in an (i−1)^{th} group of feature operation units. The exponent comparison subcomponent i−1 may input a local exponent (exp_max_in [i−1]) of the exponent comparison subcomponent i−1 to the exponent comparison subcomponent i (301); and an output end of the exponent comparison subcomponent i (301) is connected to an input end of the mantissa operation component, an input end of the second operation subunit i−1, and an input end of the exponent comparison subcomponent i+1, where the exponent comparison subcomponent i+1 is an exponent comparison subcomponent in an (i+1)^{th} group of feature operation units in the n groups of feature operation units. For operation logic between the exponent addition subcomponent and the exponent comparison subcomponent i (301), refer to the following descriptions: the exponent addition subcomponent may be configured to merge the feature exponent and the weight exponent, and output a merged exponent (exp_add) obtained through merging processing to the exponent comparison subcomponent i (301); and the exponent comparison subcomponent i (301) may be configured to compare the merged exponent with the local exponent of the exponent comparison subcomponent i−1, output an exponent having a large value to the exponent comparison subcomponent i+1 as a local exponent (exp_max_out [i]) of the exponent comparison subcomponent i (301), may be configured to determine an alignment shift amount (exp_delta [i]) of the exponent comparison subcomponent i (301) according to a difference between the merged exponent and the local exponent of the exponent comparison subcomponent i−1, and output the alignment shift amount of the exponent comparison subcomponent i (301) to the second operation subunit i−1 and the mantissa operation component as an exponent operation result.

In some embodiments, as shown in FIG. 3, the exponent comparison subcomponent i (301) may include an exponent comparison device i (cmp), an exponent exchange device (exchange), and a subtraction device (sub). The exponent comparison device i may perform a comparison operation on the merged exponent and the local exponent of the exponent comparison subcomponent i−1, send the merged exponent and the local exponent of the exponent comparison subcomponent i−1 to an exponent exchange device to perform an exchange operation after the comparison operation is performed, to obtain a maximum exponent (max) and a minimum exponent (min), and send the maximum exponent (max) and the minimum exponent (min) to the subtraction device to perform a subtraction operation, to obtain an alignment shift amount of the exponent comparison subcomponent i (301).

For the mantissa operation component (31): as shown in FIG. 3, the mantissa operation component (31) may include a mantissa multiplication subcomponent 311 and a mantissa shift subcomponent. For a connection relationship between the mantissa multiplication subcomponent (311) and the mantissa shift subcomponent, refer to the following descriptions: an input end of the mantissa multiplication subcomponent (311) may be configured to receive a feature mantissa and a weight mantissa; an input end of the mantissa shift subcomponent is connected to an output end of the mantissa multiplication subcomponent (311) and an output end of the exponent comparison subcomponent i; and an output end of the mantissa shift subcomponent is connected to an input end of the second operation subunit i. For operation logic between the mantissa multiplication subcomponent (311) and the mantissa shift subcomponent, refer to the following descriptions: the mantissa multiplication subcomponent (311) may be configured to perform a multiplication operation on the feature mantissa and the weight mantissa, and output a mantissa multiplication result of the multiplication operation to the mantissa shift subcomponent; the mantissa shift subcomponent may be configured to perform right-shift processing on the mantissa multiplication result according to an alignment shift amount of the exponent comparison subcomponent i if a merged exponent is less than the local exponent of the exponent comparison subcomponent i−1 to obtain a first operation result of the first operation subunit i, and output the first operation result of the first operation subunit i to the second operation subunit i; and output the mantissa multiplication result to the second operation subunit i as the first operation result of the first operation subunit i if the merged exponent is greater than or equal to the local exponent of the exponent comparison subcomponent i−1.

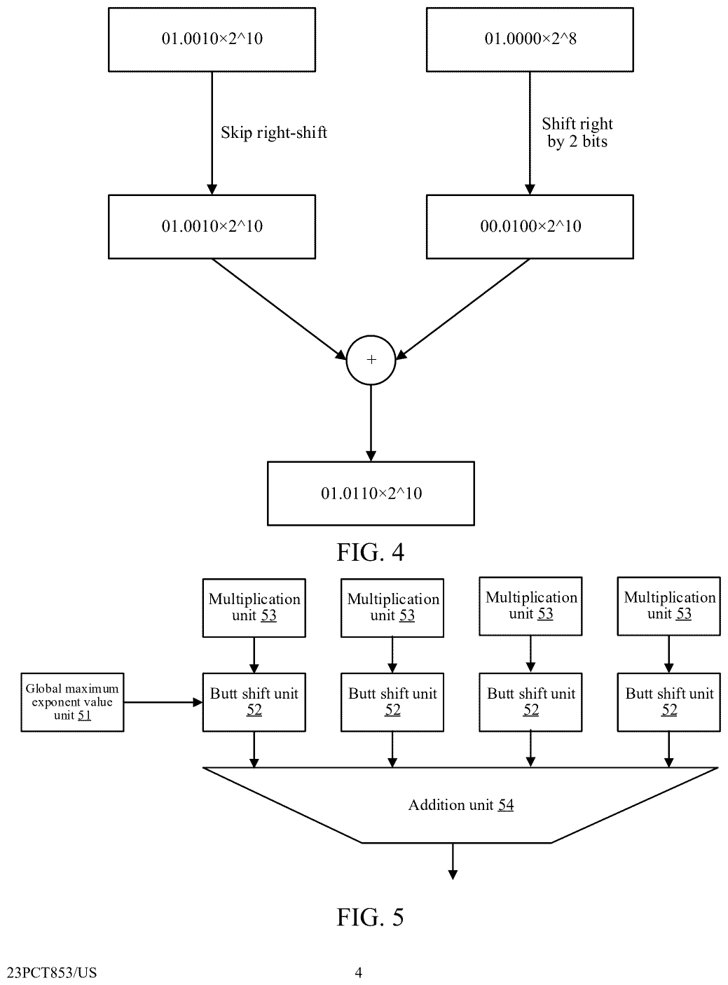

The right-shift processing in the mantissa operation component (31) may be understood as an alignment shift operation. A principle of the alignment shift operation is described herein first: essentially, the alignment shift operation is to perform a right-shift operation on mantissas of a number having a smaller exponent by taking a number having a larger exponent as a reference in the two numbers, so that the exponents of the two numbers are aligned. As shown in FIG. 4, an addition operation is performed on two numbers, an exponent of one number is 10, an exponent of the one number is 8, exponents of the two numbers are different, an alignment shift operation needs to be performed, an exponent difference between the two numbers is 2, a number with a larger exponent does not need to be shifted, a mantissa of a number with a smaller exponent needs to be shifted right by two bits, 01.0000 is shifted right by two bits to 00.0100, and then a mantissas adding operation is performed. In this embodiment of the present disclosure, the right-shift processing in the mantissa operation component (31) is to align the exponent corresponding to the mantissa multiplication result with the local exponent (exp_max_out [i]) of the exponent comparison subcomponent i (301). This facilitates directly merging mantissa parts of data in a subsequent merging operation process because the exponents of the data are aligned, thereby improving merging operation efficiency.

The local exponent (exp_max_out [i−1]) of the exponent comparison subcomponent i−1 refers to a maximum exponent value appearing in first i−1 groups of feature operation units including the (i−1)^{th} group of feature operation units. The maximum exponent value has locality. The locality is reflected in that the maximum exponent value is updated after the local exponent of the exponent comparison subcomponent i−1 is compared with the merged exponent in the i^{th} group of feature operation units. The alignment shift operation is performed by using the local maximum exponent value as a reference, instead of performing the alignment shift operation by using a global maximum exponent value as a reference in the existing systolic array shown in FIG. 5, and a matrix operation is implemented by using an accumulation tree. A function of a global maximum exponent value unit (51) is to solve a maximum value (exp max) of an exponent in a column of input, then perform an alignment shift operation on an output result of a multiplication unit (53) through a butt shift unit (52) based on the maximum value, and finally input the output result to an addition unit (54) to perform an addition operation. However, if the alignment shift operation is performed by using the global maximum exponent value as a reference, because a width of data output by the alignment shift operation is limited, the data with a relatively small exponent is entirely moved out, and a precision loss is relatively large. However, in this embodiment of the present disclosure, the alignment shift operation is performed by using the local maximum exponent value as a reference, so that precision of a previous-level operation in an alignment shift process can be kept as much as possible.

In some embodiments, as shown in FIG. 3, the mantissa multiplication subcomponent (311) may include a partial product generation device, a partial product compress device, and a carry propagation adder (CPA). An input end of the partial product generation device is configured to receive a feature mantissa and a number of weight bits, and the partial product generation device is configured to perform a partial product operation on the feature mantissa and the number of weight bits and output a partial product operation result to the partial product compress device. The partial product compress device is configured to perform a partial product compress operation on the partial product operation result and output a partial product compress result to the CPA. The CPA is configured to perform a merging operation on the partial product compress result, and output a mantissa multiplication result to a mantissa shift subcomponent.

For the second operation subunit i (ASU[i]) in the second group of feature operation units, as shown in FIG. 3, the second operation subunit i may include a merging component and a shift component (32). For a connection relationship between the merging component and the shift component (32), refer to the following descriptions: an input end of the merging component may be configured to receive a first operation result of the first operation subunit i and a feature operation result (psum_in [i−1]) of the (i−1)^{th} group of feature operation units output by the second operation subunit i−1; an input end of the shift component (32) is connected to an output end of the merging component, an output end of a first operation subunit i, and an output end of a second operation subunit i−1, the first operation subunit i inputs a first operation result of the first operation subunit i to the shift component (32), and the second operation subunit i−1 is configured to input a feature operation result of an (i−1)^{th} group of feature operation units to the shift component (32); and an output end of the shift component (32) is connected to a second operation subunit i+1 (ASU[i+1]), and the second operation subunit i+1 is a second operation subunit in an (i+1)^{th} group of feature operation units in the n groups of feature operation units. For operation logic between the merging component and the shift component (32), refer to the following descriptions: the merging component may be configured to perform merging processing on the first operation result of the first operation subunit i and the feature operation result of the (i−1)^{th} group of feature operation units to obtain an initial operation result of the i^{th} group of feature operation units, and output the initial operation result of the i^{th} group of feature operation units to the shift component (32); and the shift component (32) may be configured to perform shift processing on the initial operation result of the i^{th} group of feature operation units according to the first operation result of the first operation subunit i and the feature operation result of the (i−1)^{th} group of feature operation units to obtain a feature operation result of the i^{th} group of feature operation units, and output the feature operation result (psum_out [i]) of the i^{th} group of feature operation units to the second operation subunit i+1.

In some embodiments, as shown in FIG. 3, the shift component (32) may include a leading zero anticipator (LZA) subcomponent, a shift control subcomponent, and a shift processing subcomponent (321). For connection relationships between the LZA subcomponent, the shift control subcomponent, and the shift processing subcomponent (321), refer to the following descriptions: an input end of the LZA subcomponent may be configured to receive the first operation result of the first operation subunit i and the feature operation result of the (i−1)^{th} group of feature operation units input by the second operation subunit i−1; an input end of the shift control subcomponent is connected to an output end of the LZA subcomponent and an output end of a first operation subunit i+1 (MEU[i+1]), the first operation subunit i+1 is a first operation subunit in an (i+1)^{th} group of feature operation units in the n groups of feature operation units, and the first operation subunit i+1 outputs an alignment shift amount (exp_delta [i+1]) of the exponent comparison subcomponent i+1 in the first operation subunit i+1 to the shift control subcomponent; and an input end of the shift processing subcomponent (321) is connected to an output end of the shift control subcomponent, and an output end of the shift control subcomponent is connected to the second operation subunit i+1.

For operation logic between the LZA subcomponent, the shift control subcomponent, and the shift processing subcomponent (321), refer to the following descriptions: the LZA subcomponent may be configured to perform leading zero anticipation on the initial operation result of the i^{th} group of feature operation units according to the first operation result of the first operation subunit i and the feature operation result of the (i−1)^{th} group of feature operation units to obtain a normalized shift amount, and input the normalized shift amount to the shift control subcomponent; the shift control subcomponent may be configured to determine, according to the normalized shift amount and the alignment shift amount of the exponent comparison subcomponent i+1, a target shift direction (sft_dir) and a target shift amount (sft_amt) for performing shift processing on the initial operation result of the i^{th} group of feature operation units, and input the target shift direction and the target shift amount to the shift processing subcomponent (321); and the shift processing subcomponent (321) may be configured to perform shift processing on the initial operation result of the i^{th} group of feature operation units according to the target shift direction and the target shift amount to obtain a feature operation result of the i^{th} group of feature operation units, and output the feature operation result of the i^{th} group of feature operation units to the second operation subunit i+1.

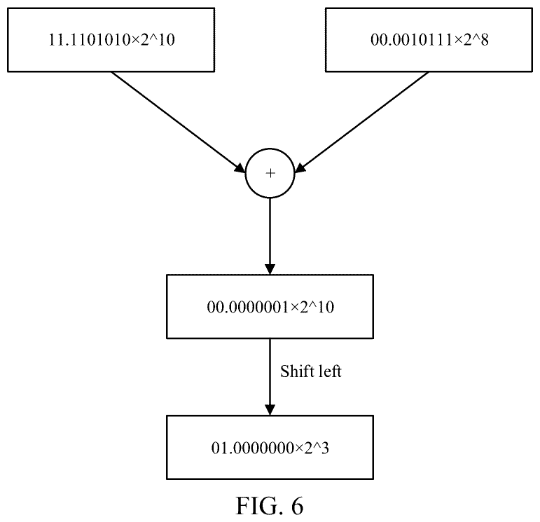

The normalized shift amount is a number of shifts configured for performing a normalized shift operation. For a principle of the normalized shift operation, refer to FIG. 6. An addition operation is performed on two numbers. One is a positive number (00.0010111×2\hat{ }10, a highest bit is a sign bit, 0 represents the positive number), and the other is a negative number (11.1101010×2\hat{ }10, a highest bit is a sign bit, and 1 represents a negative number). A calculation result of the two numbers is 00.0000001×2\hat{ }10. It can be learned that a large number of leading zeros are generated after a decimal point. If a subsequent merging operation is performed through the leading zeros, the leading zeros occupy a large number of valid bits, leading to relatively low calculation precision. The normalized shift amount is a difference between a currently anticipated number of leading zeros and a target number of leading zeros, that is, a current number of redundant leading zeros. The normalized shift operation refers to performing left-shift processing on to-be-processed data according to the normalized shift amount, so that the number of leading zeros of shifted data is aligned with the target number of leading zeros, and the redundant leading zeros are removed.

In some embodiments, as shown in FIG. 3, the shift processing subcomponent (321) may include a left-shift device, a right-shift device, and a selection device. For connection relationships between the left-shift device, the right-shift device, and the selection device, refer to the following descriptions: an input end of the left-shift device is configured to receive the target shift amount output by the shift control subcomponent and the initial operation result of the i^{th} group of feature operation units output by the merging component; an input end of the right-shift device is configured to receive the target shift amount output by the shift control subcomponent and the initial operation result of the i^{th} group of feature operation units output by the merging component; and an input end of the selection device is connected to an output end of the left-shift device, an output end of the right-shift device, and an output end of the shift control subcomponent, and an output end of the selection device is connected to the second operation subunit i+1. For operation logic between the left-shift device, the right-shift device, and the selection device, refer to the following descriptions: the left-shift device may be configured to perform left-shift processing on the initial operation result of the i^{th} group of feature operation units according to the target shift amount to obtain a left-shift result, and output the left-shift result to the selection device; the right-shift device may be configured to perform right-shift processing on the initial operation result of the i^{th} group of feature operation units according to the target shift amount to obtain a right-shift result, and output the right-shift result to selection device; and the selection device may be configured to select a feature operation result of the i^{th} group of feature operation units from the left-shift result and the right-shift result according to the target shift direction input by the shift control subcomponent, and output the feature operation result of the i^{th} group of feature operation units to the second operation subunit i+1.

For the shift control subcomponent in the second operation subunit i, the normalized shift amount and the alignment shift amount are both input to the shift control subcomponent. The normalized shift amount corresponds to a normalized shift operation, the normalized shift operation needs to perform a left shift on data. The alignment shift amount corresponds to an alignment shift operation, and the alignment shift operation needs to perform a right shift on data. The shift control subcomponent may merge the normalized shift operation and the alignment shift operation to determine a final number of shifts (that is, a target shift amount) and a final shift direction (that is, a target shift direction). In this way, a merging operation delay of the second operation subunit may be reduced, thereby reducing an overall delay of a systolic array and improving feature operation efficiency of the systolic array. In addition, after the final number of shifts (that is, the target shift amount) and the final shift direction (that is, the target shift direction) are determined, the left-shift processing performed by the left-shift device based on the target shift amount and the right-shift processing performed by the right-shift device based on the target shift amount are performed in parallel, then a shift result corresponding to the target shift direction may be selected from the left-shift result and the right-shift result through the target shift direction as a feature operation result of the i^{th} group of feature operation units for output. The left-shift processing performed by the left-shift device based on the target shift amount and the right-shift processing performed by the right-shift device based on the target shift amount are performed in parallel, which may further reduce the merging operation delay of the second operation subunit, thereby reducing the overall delay of the systolic array, and improving the feature operation efficiency of the systolic array.

The foregoing content describes structures of the first operation subunit and the second operation subunit that belong to the same group of feature operation units. Based on this, the following describes a clock cycle control process between the first operation subunit and the second operation subunit that belong to the same group of feature operation units, using the first operation subunit i and the second operation subunit i in the i^{th} group of feature operation units as an example:

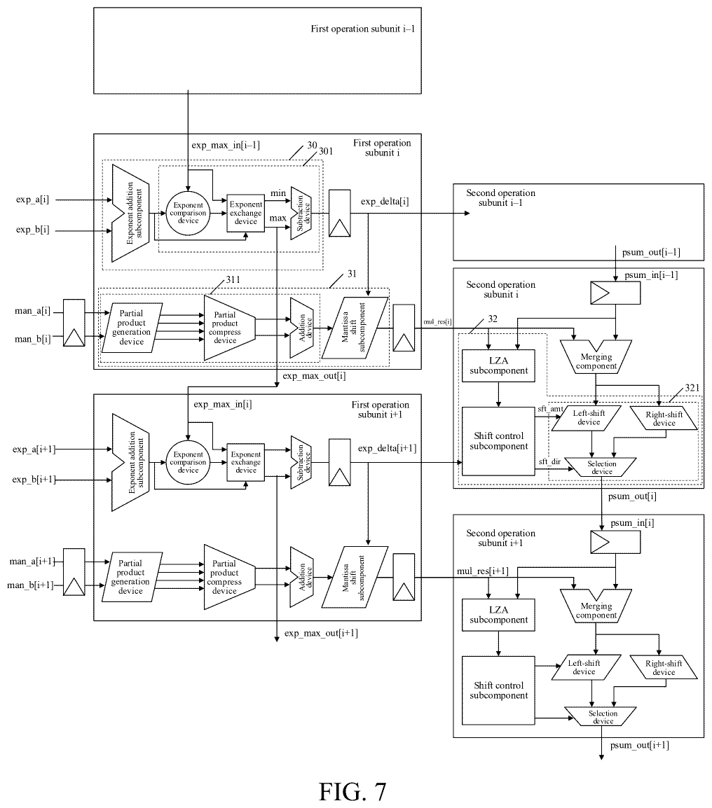

a time at which the exponent operation component (30) in the first operation subunit i starts the exponent operation is at least one clock cycle earlier than a time at which the mantissa operation component (31) starts the mantissa operation. In some embodiments, the data processing apparatus may further include a beater. The beater may control a feature operation process of the i^{th} group of feature operation units through beat processing. A time interval between two rounds of consecutive beat processing performed by the beater is at least one preset clock cycle. As shown in FIG. 7, the exponent operation component (30) is controlled to start an exponent operation when a beater performs a first round of beat processing at a time Tᵢ; the exponent operation component (30) is controlled to obtain an exponent operation result (that is, an alignment shift amount), and the mantissa operation component (31) is controlled to start a mantissa operation the beater is performs a second round of beat processing at a time Tᵢ₊₁; the mantissa operation component (31) is controlled to obtain a first operation result of the first operation subunit i, and the second operation subunit i is controlled to start a merging budget when the beater performs a third round of beat processing at a time Tᵢ₊₂; and the second operation subunit i is controlled to obtain the feature operation result of an i^{th} group of feature operation units when the beater performs a fourth round of beat processing at a time Tᵢ₊₃. Each of a time interval between the time Tᵢ₊₁ and the time Tᵢ, a time interval between the time Tᵢ₊₂ and the time Tᵢ₊₁, a time interval between the Tᵢ₊₃ and the time Tᵢ₊₂ is a time interval between two rounds of consecutive beat processing of the beater. It can be learned that the second operation subunit i can complete merging of the first operation result of the first operation subunit i and the feature operation result of the (i−1)^{th} group of feature operation units in at least one clock cycle.

As shown in FIG. 7, for a first operation subunit i in the i^{th} group of feature operation units, an exponent part is input at the time Tᵢ, beat processing is immediately performed after an exponent operation, and an alignment shift amount (exp_delta [i]) is obtained at the time Tᵢ. Beat processing is immediately performed after a mantissa part is input at the time Tᵢ, a mantissa operation is performed at a stage Tᵢ₊₁, then beat processing is performed, and the mantissa part is sent to the second operation subunit i for a merging operation at the time Tᵢ₊₂. It can be learned that, to ensure that two addends meet at the same beat in the second operation subunit i, a time at which the exponent part starts the exponent operation is a beat (at least one clock cycle) earlier than a time at which the mantissa part starts the mantissa operation. For an (i+1)^{th} group of feature operation units, an exponent part needs to be input at the time Tᵢ₊₁. This is because a merging operation process of the second operation subunit in the i^{th} group of feature operation units needs at least one clock cycle, that is, the i^{th} group of feature operation units needs to perform a first-level weighting operation and a first-level merging operation to obtain a feature operation result psum_in [i] of the i^{th} group of feature operation units, an (i+1)^{th} group of feature operation units needs to perform a first-level weighting operation to obtain a first operation result mul_res [i+1] of a first operation subunit i+1 in the (i+1)^{th} group of feature operation units, and beat processing needs to be performed on an input of the (i+1)^{th} group of feature operation units, so that mul_res[i+1] and psum_in[i] are aligned.

Based on the foregoing introduction of structures of the first operation subunit and the second operation subunit that belong to the same group of feature operation units, it may be learned that: in this embodiment of the present disclosure, an alignment shift operation is performed by using a local maximum exponent value as a reference. In this way, precision of a previous-level operation in the alignment shift process can be reserved as much as possible. Moreover, the shift control subcomponent may merge the normalized shift operation and the alignment shift operation to determine a final number of shifts (that is, a target shift amount) and a final shift direction (that is, a target shift direction). In this way, a merging operation delay of the second operation subunit may be reduced, thereby reducing an overall delay of a systolic array and improving feature operation efficiency of the systolic array.

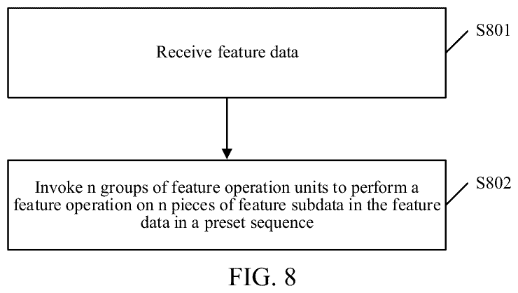

Based on the structure of the foregoing data processing apparatus, an embodiment of the present disclosure provides a data processing method. The data processing method is applied to the foregoing data processing apparatus. In addition, because the data processing apparatus may be an apparatus in an AI processor, the data processing method may alternatively be a method implemented by the AI processor. As shown in FIG. 8, the data processing method may include, but is not limited to, the following operation S801 to operation S802.

S801: Receive feature data.

S802: Invoke n groups of feature operation units to perform a feature operation on n pieces of feature subdata in the feature data in a preset sequence.

Herein, the n groups of feature operation units may perform the feature operation on the n pieces of feature subdata in the preset sequence, and in the preset sequence, in any two adjacent groups of feature operation units, a time at which a first group of feature operation units starts the feature operation is at least one preset clock cycle earlier than a time at which a second group of feature operation units starts the feature operation. Any group of feature operation units in the n groups of feature operation units may be represented as an i^{th} group of feature operation units, where i is an integer greater than or equal to 1, and i is less than or equal to n. The invoking n groups of feature operation units to perform a feature operation on n pieces of feature subdata in the feature data in a preset sequence may be implemented in the following mode: invoking the i^{th} group of feature operation units to perform the feature operation on an i^{th} piece of feature subdata in the n pieces of feature subdata to obtain a feature operation result of the i^{th} group of feature operation units.

In some embodiments, the i^{th} group of feature operation units includes a first operation subunit i and a second operation subunit i; in the n groups of feature operation units, a previous group of feature operation units adjacent to the i^{th} group of feature operation units is an (i−1)^{th} group of feature operation units, and the (i−1)^{th} group of feature operation is configured to perform the feature operation on an (i−1)^{th} piece of feature subdata in the n pieces of feature subdata to obtain a feature operation result of the (i−1)^{th} group of feature operation units; and the invoking the i^{th} group of feature operation units to perform the feature operation on an i^{th} piece of feature subdata in the n pieces of feature subdata to obtain a feature operation result of the i^{th} group of feature operation units is configured for performing the following operations: the first operation subunit i is invoked to perform first operation processing on the i^{th} piece of feature subdata to obtain a first operation result; and the second operation subunit i is invoked to perform second operation processing on the first operation result and the feature operation result of the (i−1)^{th} group of feature operation units to obtain a feature operation result of the i^{th} group of feature operation units.

The following separately describes a process of the first operation processing and a process of the second operation processing:

for the first operation processing, the first operation processing may include weighting operation processing; each of the n groups of feature operation units separately corresponds to a weight, and the weight corresponding to an i^{th} group of feature operation units is represented as an i^{th} weight; the i^{th} piece of feature subdata may be decomposed into a feature exponent and a feature mantissa, and the i^{th} weight may be decomposed into a weight exponent and a weight mantissa; the weighting operation processing may be decomposed into an exponent operation and a mantissa operation; and the first operation subunit i may include an exponent operation component and a mantissa operation component. In this embodiment of the present disclosure, the process of the first operation processing may further include: invoking the exponent operation component to perform an exponent operation on the feature exponent and the weight exponent to obtain an exponent operation result of the exponent operation component; and then, invoking the mantissa operation component to perform a mantissa operation on the feature mantissa, the weight mantissa, and the exponent operation result of the exponent operation component to obtain a first operation result of the first operation subunit i.

For example, the exponent operation component may include an exponent addition subcomponent and an exponent comparison subcomponent i, and the exponent addition subcomponent may be invoked to merge the feature exponent and the weight exponent to obtain a merged exponent. Then, the exponent comparison subcomponent i may be invoked to compare the merged exponent with the local exponent of the exponent comparison subcomponent i−1, and an exponent with a larger value is used as the local exponent of the exponent comparison subcomponent i and is output to the exponent comparison subcomponent i+1. The exponent comparison subcomponent is invoked to determine an alignment shift amount of the exponent comparison subcomponent i according to a difference between the merged exponent and the local exponent of the exponent comparison subcomponent i−1, and output the alignment shift amount of the exponent comparison subcomponent i to the second operation subunit i−1 and the mantissa operation component as an exponent operation result. The exponent comparison subcomponent i−1 is an exponent comparison subcomponent in an (i−1)^{th} group of feature operation units, the exponent comparison subcomponent i+1 is an exponent comparison subcomponent in an (i+1)^{th} group of feature operation units in the n groups of feature operation units, and the second operation subunit i−1 is a second operation subunit in the (i−1)^{th} group of feature operation units.

The mantissa operation component may include a mantissa multiplication subcomponent and a mantissa shift subcomponent, and the mantissa multiplication subcomponent may be invoked to perform a multiplication operation on the feature mantissa and the weight mantissa to obtain a mantissa multiplication result. The mantissa shift subcomponent is invoked to perform right-shift processing on the mantissa multiplication result according to the alignment shift amount of the exponent comparison subcomponent i to obtain the first operation result of the first operation subunit if the merged exponent is less than the local exponent of the exponent comparison subcomponent i−1; and the mantissa shift subcomponent is invoked to use the mantissa multiplication result as the first operation result of the first operation subunit i if the merged exponent is greater than or equal to the local exponent of the exponent comparison subcomponent i−1.

For the second operation processing, the second operation processing may include merging operation processing; the second operation subunit i may include a merging component and a shift component, and the process of the second operation processing may include: invoking the merging component to merge the first operation result of the first operation subunit i and the feature operation result of the (i−1)^{th} group of feature operation units to obtain an initial operation result of the i^{th} group of feature operation units; and then, invoking the shift component to perform shift processing on the initial operation result of the i^{th} group of feature operation units according to the first operation result of the first operation subunit i and the feature operation result of the (i−1)^{th} group of feature operation units to obtain the feature operation result of the i^{th} group of feature operation units.

The shift component may include a LZA subcomponent, a shift control subcomponent, and a shift processing subcomponent, the invoking the shift component to perform shift processing on the initial operation result of the i^{th} group of feature operation units according to the first operation result of the first operation subunit i and the feature operation result of the (i−1)^{th} group of feature operation units to obtain the feature operation result of the i^{th} group of feature operation units is configured for performing the following operations: the LZA subcomponent may be invoked to perform leading zero anticipation on the initial operation result of the i^{th} group of feature operation units according to the first operation result of the first operation subunit i and the feature operation result of the (i−1)^{th} group of feature operation units to obtain a normalized shift amount; and then, the shift component may be invoked to determine, according to the normalized shift amount and the alignment shift amount of the exponent comparison subcomponent i+1, a target shift direction and a target shift amount for performing shift processing on the initial operation result of the i^{th} group of feature operation units. The normalized shift amount corresponds to the normalized shift operation mentioned above, and the normalized shift operation is a left-shift operation. The alignment shift amount corresponds to the alignment shift operation mentioned above, and the alignment shift operation is a right-shift operation. The target shift amount may be a shift variation between the normalized shift amount and the alignment shift amount, and the target shift direction may be a shift direction corresponding to a larger shift amount of the normalized shift amount and the alignment shift amount. The exponent comparison subcomponent i+1 is an exponent comparison subcomponent in an (i+1)^{th} group of feature operation units in the n groups of feature operation units. Then, the shift processing subcomponent may be invoked to perform shift processing on the initial operation result of the i^{th} group of feature operation units according to the target shift direction and the target shift amount to obtain a feature operation result of the i^{th} group of feature operation units.

In some embodiments, the shift processing subcomponent may include a left-shift device, a right-shift device, and a selection device. A process of invoking the shift processing subcomponent to perform shift processing on the initial operation result of the i^{th} group of feature operation units according to the target shift direction and the target shift amount to obtain a feature operation result of the i^{th} group of feature operation units may include: the left-shift device may be invoked to perform left-shift processing on the initial operation result of the i^{th} group of feature operation units according to the target shift amount to obtain a left-shift result; the right-shift device is invoked to perform right-shift processing on the initial operation result of the i^{th} group of feature operation units according to the target shift amount to obtain a right-shift result; and then, the selection device may be invoked to select a feature operation result of the i^{th} group of feature operation units from the left-shift result and the right-shift result according to the target shift direction input by the shift control subcomponent.

The feature operation module may further include a precision control unit, and the precision control unit may further be invoked to perform precision control processing on a feature operation result of an nth group of feature operation units in the n groups of feature operation units to obtain a feature operation result of the feature data in the feature operation module. A systolic array includes m feature operation modules, and each of the m feature operation modules performs a feature operation on the feature data to obtain a feature operation result of the feature data under each feature operation module; m is an integer greater than or equal to 1; and in any two adjacent feature operation modules in the m feature operation modules, a time at which a previous feature operation module starts the feature operation is at least one preset clock cycle earlier than a time at which a later feature operation module starts the feature operation.

In this embodiment of the present disclosure, a time interval for starting the feature operation between any two adjacent groups of feature operation units in the systolic array may be controlled. The time interval is at least one preset clock cycle. That is, in this embodiment of the present disclosure, the time interval for starting the feature operation between any two adjacent groups of feature operation units in the systolic array may be properly controlled. In this way, a data operation delay of the systolic array can be reduced, and data operation efficiency of the systolic array can be improved.

An embodiment of the present disclosure further provides an AI processor. The data processing apparatus in the foregoing embodiments is provided in the AI processor. The foregoing data processing apparatus is configured to perform the foregoing data processing method.

An embodiment of the present disclosure further provides a computer-readable storage medium. The computer-readable storage medium stores a computer program. The computer program enables the AI processor to perform the foregoing data processing method when read and executed by the AI processor.

An embodiment of the present disclosure provides a computer program product. The computer program product includes a computer program. The computer program is stored in a computer-readable storage medium. The AI processor reads the computer program from the computer-readable storage medium. The AI processor executes the computer program to enable the AI processor to perform the foregoing data processing method.

As disclosed, the systolic array provided in the data processing apparatus may be configured to perform a feature operation on feature data. The feature data is obtained by performing feature extraction on service data of a target service. The feature data may include n pieces of feature subdata arranged in sequence. The feature operation module in the systolic array may include n groups of feature operation units, and the n groups of feature operation units may be separately configured to perform the feature operation on a corresponding piece of feature subdata in the feature data. The n groups of feature operation units may perform feature operation on the n pieces of feature subdata in a preset sequence, and in the preset sequence, in any two adjacent groups of feature operation units, a time at which a previous group of feature operation units starts the feature operation is at least one preset clock cycle earlier than a time at which a later group of feature operation units starts the feature operation. In this embodiment of the present disclosure, a time interval for starting the feature operation between any two adjacent groups of feature operation units in the systolic array may be controlled. The time interval is at least one preset clock cycle. That is, in this embodiment of the present disclosure, a feature operation process may be controlled by properly controlling the time interval for starting the feature operation between any two adjacent groups of feature operation units in the systolic array, so that a data operation delay of the systolic array is less than a delay threshold, that is, the data operation delay of the systolic array is controlled to be within a relatively small range, thereby reducing the data operation delay of the systolic array, and improving data operation efficiency of the systolic array.

The foregoing descriptions are merely specific implementations of the present disclosure, but are not intended to limit the protection scope of the present disclosure. Any variation or replacement readily figured out by a person skilled in the art within the technical scope disclosed in the present disclosure shall fall within the protection scope of the present disclosure. Therefore, the scope of protection of the present disclosure is to be subject to the scope of protection of the claims.

What is claimed is:

1. A data processing apparatus, provided with a systolic array configured to perform a feature operation on feature data obtained from feature extraction on service data of a target service, the feature data comprising n pieces of feature subdata arranged in sequence, and n being an integer greater than or equal to 1;
the systolic array comprising a feature operation module, the feature operation module comprising n groups of feature operation units, the n groups of feature operation units being configured to perform the feature operation on the n pieces of feature subdata in the feature data, and the n groups of feature operation units being connected according to association operation logic between the n pieces of feature subdata;
a group of feature operation units comprising a first operation subunit and a second operation subunit, and the first operation subunit and the second operation subunit being connected according to feature operation logic of the corresponding feature subdata; and
the n groups of feature operation units performing the feature operation on the n pieces of feature subdata in a preset sequence corresponding to the association operation logic, and in the preset sequence, in any two adjacent groups of feature operation units, a time at which a first group of feature operation units starts the feature operation is at least one preset clock cycle earlier than a time at which a second group of feature operation units starts the feature operation.

2. The data processing apparatus according to claim 1, wherein any two pieces of feature subdata arranged adjacently in the n pieces of feature subdata are denoted as an (i−1)^{th} piece of feature subdata and an i^{th} piece of feature subdata; i is an integer greater than 1, and i is less than or equal to n;
any two adjacent groups of feature operation units in the n groups of feature operation units are denoted as an (i−1)^{th} group of feature operation units and an i^{th} group of feature operation units, and the (i−1)^{th} group of feature operation units is configured to perform the feature operation on the (i−1)^{th} piece of feature subdata; the i^{th} group of feature operation units is configured to perform the feature operation on the i^{th} piece of feature subdata; and
the association operation logic between the n pieces of feature subdata comprises: a feature operation sequence of the (i−1)^{th} piece of feature subdata precedes a feature operation sequence of the i^{th} piece of feature subdata, and a feature operation result of the (i−1)^{th} piece of feature subdata is applied to a feature operation process of the i^{th} piece of feature subdata; and
the (i−1)^{th} group of feature operation units is connected to the i^{th} group of feature operation units according to the association operation logic between the n pieces of feature subdata.

3. The data processing apparatus according to claim 2, further comprising a beater, wherein the beater is configured to control the feature operation process between the n groups of feature operation units through beat processing, and a time interval between two rounds of consecutive beat processing performed by the beater includes at least one preset clock cycle;
the (i−1)^{th} group of feature operation units is controlled to start the feature operation on the (i−1)^{th} piece of feature subdata when the beater performs a round of beat processing at a time Tᵢ₋₁; the i^{th} group of feature operation units is controlled to start the feature operation on the i^{th} piece of feature subdata when the beater performs a next round of beat processing at a time Tᵢ adjacent to the beat processing at the time Tᵢ₋₁; and
a time interval between the time Tᵢ₋₁ and the time Tᵢ is a time interval between the two rounds of consecutive beat processing performed by the beater.

4. The data processing apparatus according to claim 2, wherein the feature operation logic of the i^{th} piece of feature subdata comprises: performing first operation processing on the i^{th} piece of feature subdata, and applying a feature operation result of the first operation processing to a process of second operation processing;
an input end of a first operation subunit i in the i^{th} group of feature operation units is configured to receive the i^{th} piece of feature subdata, and to perform the first operation processing on the i^{th} piece of feature subdata; and an output end of the first operation subunit i is connected to an input end of a second operation subunit i in the i^{th} group of feature operation units, and an input end of the second operation subunit i is configured to receive a first operation result of the first operation subunit i, and to perform the second operation processing on the first operation result, to obtain a feature operation result of the i^{th} group of feature operation units.

5. The data processing apparatus according to claim 4, wherein the (i−1)^{th} group of feature operation units is connected to the i^{th} group of feature operation units in following mode:
the second operation subunit i−1 in the (i−1)^{th} group of feature operation units is connected to the second operation subunit i in the i^{th} group of feature operation units.

6. The data processing apparatus according to claim 4, wherein the first operation processing comprises weighting operation processing, and the second operation processing comprises merging operation processing; and
a group of the n groups of feature operation units corresponds to a weight, and the weight corresponding to the i^{th} group of feature operation units is configured for: performing, by the first operation subunit i in the i^{th} group of feature operation units, the weighting operation processing on the i^{th} piece of feature subdata by using the weight, to obtain the first operation result of the first operation subunit i.

7. The data processing apparatus according to claim 6, wherein the weight corresponding to the i^{th} group of feature operation units is represented as an i^{th} weight; the i^{th} piece of feature subdata is decomposed into a feature exponent and a feature mantissa, and the i^{th} weight is decomposed into a weight exponent and a weight mantissa; the weighting operation processing is decomposed into an exponent operation and a mantissa operation;
the first operation subunit i comprises an exponent operation component and a mantissa operation component;
an input end of the exponent operation component is configured to receive the feature exponent and the weight exponent, and an output end of the exponent operation component is connected to the mantissa operation component and the second operation subunit i−1; the exponent operation component is configured to perform the exponent operation on the feature exponent and the weight exponent, and output an exponent operation result of the exponent operation component to the mantissa operation component and the second operation subunit i−1;
an input end of the mantissa operation component is configured to receive the feature mantissa, the weight mantissa, and the exponent operation result of the exponent operation component, and an output end of the mantissa operation component is connected to the input end of the second operation subunit i; and the mantissa operation component is configured to perform the mantissa operation on the feature mantissa, the weight mantissa, and the exponent operation result of the exponent operation component, to obtain the first operation result of the first operation subunit i, wherein
a time at which the exponent operation component starts the exponent operation is at least one clock cycle earlier than a time at which the mantissa operation component starts the mantissa operation.

8. The data processing apparatus according to claim 7, further comprising a beater, wherein the beater controls the feature operation process of the i^{th} group of feature operation units through beat processing, and a time interval between two rounds of consecutive beat processing by the beater is at least one preset clock cycle;
the exponent operation component starts the exponent operation when the beater performs a round of beat processing at the time Tᵢ;
the exponent operation component obtains the exponent operation result and the mantissa operation component starts the mantissa operation when the beater performs a second round of beat processing at the time Tᵢ₊₁;
the mantissa operation component obtains the first operation result of the first operation subunit and the second operation subunit i starts a merging budget when the beater performs a third round of beat processing at a time Tᵢ₊₂;
the second operation subunit i obtains the feature operation result of the i^{th} group of feature operation units when the beater performs a fourth round of beat processing at a time Tᵢ₊₃; and
each of a time interval between the time Tᵢ₊₁ and the time Tᵢ, a time interval between the Tᵢ₊₂ and the time Tᵢ₊₁, and a time interval between the Tᵢ₊₃ and the time Tᵢ₊₂ is a time interval between two rounds of consecutive beat processing of the beater.

9. The data processing apparatus according to claim 8, wherein the exponent operation component comprises an exponent addition subcomponent and an exponent comparison subcomponent i;
an input end of the exponent addition subcomponent is configured to receive the feature exponent and the weight exponent;
an input end of the exponent comparison subcomponent i is connected to an output end of the exponent addition subcomponent and an output end of the exponent comparison subcomponent i−1, the exponent comparison subcomponent i−1 is an exponent comparison subcomponent in the (i−1)^{th} group of feature operation units, and the exponent comparison subcomponent i−1 inputs a local exponent of the exponent comparison subcomponent i−1 to the exponent comparison subcomponent i;
an output end of the exponent comparison subcomponent i is connected to the input end of the mantissa operation component, an input end of the second operation subunit i−1, and an input end of an exponent comparison subcomponent i+1, and the exponent comparison subcomponent i+1 is an exponent comparison subcomponent in an (i+1)^{th} group of feature operation units in the n groups of feature operation units;
the exponent addition subcomponent is configured to perform merging processing on the feature exponent and the weight exponent, and output a merged exponent obtained through the merging processing to the exponent comparison subcomponent i;
the exponent comparison subcomponent i is configured to compare the merged exponent with a local exponent of the exponent comparison subcomponent i−1, and output an exponent having a larger value after comparison to the exponent comparison subcomponent i+1 as the local exponent of the exponent comparison subcomponent i; and
the exponent comparison subcomponent i is further configured to determine, according to a difference between the merged exponent and the local exponent of the exponent comparison subcomponent i−1, an alignment shift amount of the exponent comparison subcomponent i, and output the alignment shift amount of the exponent comparison subcomponent i to the second operation subunit i−1 and the mantissa operation component as the exponent operation result.

10. The data processing apparatus according to claim 9, wherein the mantissa operation component comprises a mantissa multiplication subcomponent and a mantissa shift subcomponent;
an input end of the mantissa multiplication subcomponent is configured to receive the feature mantissa and the weight mantissa;
an input end of the mantissa shift subcomponent is connected to an output end of the mantissa multiplication subcomponent and the output end of the exponent comparison subcomponent i; an output end of the mantissa shift subcomponent is connected to the input end of the second operation subunit i;
the mantissa multiplication subcomponent is configured to perform a multiplication operation on the feature mantissa and the weight mantissa, and output a mantissa multiplication result of the multiplication operation to the mantissa shift subcomponent;
the mantissa shift subcomponent is configured to perform right-shift processing on the mantissa multiplication result according to the alignment shift amount of the exponent comparison subcomponent i if the merged exponent is less than the local exponent of the exponent comparison subcomponent i−1 to obtain the first operation result of the first operation subunit i, and output the first operation result of the first operation subunit i to the second operation subunit i; and
the mantissa shift subcomponent is further configured to output the mantissa multiplication result to the second operation subunit i as the first operation result of the first operation subunit i if the merged exponent is greater than or equal to the local exponent of the exponent comparison subcomponent i−1.

11. The data processing apparatus according to claim 4, wherein the second operation subunit i comprises a merging component and a shift component; an input end of the merging component is configured to receive the first operation result of the first operation subunit i and a feature operation result of the (i−1)^{th} group of feature operation units output by the second operation subunit i−1;
an input end of the shift component is connected to an output end of the merging component, and the output end of the first operation subunit i and an output end of the second operation subunit i−1;
the first operation subunit i is configured to input the first operation result of the first operation subunit i to the shift component, and the second operation subunit i−1 is configured to input the feature operation result of the (i−1)^{th} group of feature operation units to the shift component;
an output end of the shift component is connected to a second operation subunit i+1, and the second operation subunit i+1 is a second operation subunit in an (i+1)^{th} group of feature operation units in the n groups of feature operation units;
the merging component is configured to perform merging processing on the first operation result of the first operation subunit i and the feature operation result of the (i−1)^{th} group of feature operation units to obtain an initial operation result of the i^{th} group of feature operation units, and output the initial operation result of the i^{th} group of feature operation units to the shift component; and
the shift component is configured to perform shift processing on the initial operation result of the i^{th} group of feature operation units according to the first operation result of the first operation subunit i and the feature operation result of the (i−1)^{th} group of feature operation units to obtain a feature operation result of the i^{th} group of feature operation units, and output the feature operation result of the i^{th} group of feature operation units to the second operation subunit i+1.

12. The data processing apparatus according to claim 11, wherein the shift component comprises a leading zero anticipator (LZA) subcomponent, a shift control subcomponent, and a shift processing subcomponent;
an input end of the LZA subcomponent is configured to receive the first operation result of the first operation subunit i and the feature operation result of the (i−1)^{th} group of feature operation units input by the second operation subunit i−1;
an input end of the shift control subcomponent is connected to an output end of the LZA subcomponent and an output end of the first operation subunit i+1; the first operation subunit i+1 is a first operation subunit in the (i+1)^{th} group of feature operation units in the n groups of feature operation units, and the first operation subunit i+1 is configured to output the alignment shift amount of the exponent comparison subcomponent i+1 in the first operation subunit i+1 to the shift control subcomponent;
an input end of the shift processing subcomponent is connected to an output end of the shift control subcomponent, and the output end of the shift control subcomponent is connected to the second operation subunit i+1;
the LZA subcomponent is configured to perform leading zero anticipation on the initial operation result of the i^{th} group of feature operation units according to the first operation result of the first operation subunit i and the feature operation result of the (i−1)^{th} group of feature operation units to obtain a normalized shift amount, and output the normalized shift amount to the shift control subcomponent;
the shift control subcomponent is configured to determine, according to the normalized shift amount and the alignment shift amount of the exponent comparison subcomponent i+1, a target shift direction and a target shift amount for performing shift processing on the initial operation result of the i^{th} group of feature operation units, and input the target shift direction and the target shift amount to the shift processing subcomponent; and
the shift processing subcomponent is configured to perform shift processing on the initial operation result of the i^{th} group of feature operation units according to the target shift direction and the target shift amount to obtain the feature operation result of the i^{th} group of feature operation units, and output the feature operation result of the i^{th} group of feature operation units to the second operation subunit i+1.

13. The data processing apparatus according to claim 12, wherein the shift processing subcomponent comprises a left-shift device, a right-shift device, and a selection device;
an input end of the left-shift device is configured to receive the target shift amount output by the shift control subcomponent and the initial operation result of the i^{th} group of feature operation units output by the merging component;
an input end of the right-shift device is configured to receive the target shift amount output by the shift control subcomponent and the initial operation result of the i^{th} group of feature operation units output by the merging component;
an input end of the selection device is connected to an output end of the left-shift device, an output end of the right-shift device is connected to the output end of the shift control subcomponent, and an output end of the selection device is connected to the second operation subunit i+1;
the left-shift device is configured to perform left-shift processing on the initial operation result of the i^{th} group of feature operation units according to the target shift amount to obtain a left-shift result, and output the left-shift result to the selection device;
the right-shift device is configured to perform right-shift processing on the initial operation result of the i^{th} group of feature operation units according to the target shift amount to obtain a right-shift result, and output the right-shift result to the selection device; and
the selection device is configured to select a feature operation result of the i^{th} group of feature operation units from the left-shift result and the right-shift result according to the target shift direction input by the shift control subcomponent, and output the feature operation result of the i^{th} group of feature operation units to the second operation subunit i+1.

14. The data processing apparatus according to claim 1, wherein the feature operation module further comprises a precision control unit, and an input end of the precision control unit is configured to receive a feature operation result of an n^{th} group of feature operation units in the n groups of feature operation units; and
the precision control unit is configured to perform precision control processing on the feature operation result of the n^{th} group of feature operation units to obtain a feature operation result of the feature data under the feature operation module.

15. The data processing apparatus according to claim 1, wherein the systolic array comprises m feature operation modules, and the m feature operation modules are respectively configured to perform a feature operation on the feature data to obtain a feature operation result of the feature data under a corresponding feature operation module; m is an integer greater than or equal to 1; and
in any two adjacent feature operation modules in the m feature operation modules, a time at which a first feature operation module starts the feature operation is at least one preset clock cycle earlier than a time at which a second feature operation module starts the feature operation.

16. A data processing method, applied to a data processing apparatus provided with a systolic array comprising a feature operation module that includes n groups of feature operation units, and n being an integer greater than or equal to 1, the method comprising:
receiving feature data, the feature data being obtained by performing feature extraction on service data of a target service, and the feature data comprising n pieces of feature subdata arranged in sequence; and
invoking the n groups of feature operation units to perform a feature operation on the n pieces of feature subdata in a preset sequence, the n groups of feature operation units being configured to perform the feature operation on the n pieces of feature subdata in the feature data, the n groups of feature operation units being connected according to association operation logic between the n pieces of feature subdata,
a group of feature operation units comprising a first operation subunit and a second operation subunit, and the first operation subunit and the second operation subunit being connected according to feature operation logic of the corresponding feature subdata, and
in the preset sequence, in any two adjacent groups of feature operation units, a time at which a first group of feature operation units starts the feature operation is at least one preset clock cycle earlier than a time at which a second group of feature operation units starts the feature operation.

17. The method according to claim 16, wherein any group of the n groups of feature operation units is denoted as an i^{th} group of feature operation units, i is an integer greater than or equal to 1, and i is less than or equal to n; and invoking the n groups of feature operation units in the feature data to perform the feature operation on the n pieces of feature subdata in the preset sequence comprises:
invoking the i^{th} group of feature operation units to perform the feature operation on an i^{th} piece of feature subdata in the n pieces of feature subdata to obtain a feature operation result of the i^{th} group of feature operation units.

18. The method according to claim 17, wherein the i^{th} group of feature operation units comprises a first operation subunit i and a second operation subunit i; in the n groups of feature operation units, a preceding group of feature operation units adjacent to the i^{th} group of feature operation units is an (i−1)^{th} group of feature operation units, and the (i−1)^{th} group of feature operation units is configured to perform the feature operation on an (i−1)^{th} piece of feature subdata in the n pieces of feature subdata to obtain a feature operation result of the (i−1)^{th} group of feature operation units; and
invoking the i^{th} group of the feature operation units to perform the feature operation on the i^{th} piece of feature subdata in the n pieces of feature subdata to obtain the feature operation result of the i^{th} group of feature operation units comprises:
invoking the first operation subunit i to perform first operation processing on the i^{th} piece of feature subdata to obtain a first operation result; and
invoking the second operation subunit i to perform second operation processing on the first operation result and the feature operation result of the (i−1)^{th} group of feature operation units to obtain the feature operation result of the i^{th} group of feature operation units.

19. The method according to claim 18, wherein the first operation processing comprises weighting operation processing; a group of the n groups of feature operation units corresponds to a weight, and the weight corresponding to the i^{th} group of feature operation units is represented as an i^{th} weight; the i^{th} piece of feature subdata is decomposed into a feature exponent and a feature mantissa, and the i^{th} weight is decomposed into a weight exponent and a weight mantissa; the weighting operation processing is decomposed into an exponent operation and a mantissa operation; the first operation subunit i comprises an exponent operation component and a mantissa operation component;
invoking the first operation subunit i to perform first operation processing on the i^{th} piece of feature subdata to obtain the first operation result comprises:
invoking the exponent operation component to perform an exponent operation on the feature exponent and the weight exponent to obtain an exponent operation result of the exponent operation component; and
invoking the mantissa operation component to perform a mantissa operation on the feature mantissa, the weight mantissa, and the exponent operation result of the exponent operation component to obtain a first operation result of the first operation subunit i.

20. A non-transitory computer-readable storage medium containing a computer program that, when being executed, causes an Artificial Intelligence (AI) processor to perform a data processing method applied to a data processing apparatus provided with a systolic array comprising a feature operation module that includes n groups of feature operation units, and n being an integer greater than or equal to 1, the method comprising:
receiving feature data, the feature data being obtained by performing feature extraction on service data of a target service, and the feature data comprising n pieces of feature subdata arranged in sequence; and
invoking the n groups of feature operation units to perform a feature operation on the n pieces of feature subdata in a preset sequence, the n groups of feature operation units being configured to perform the feature operation on the n pieces of feature subdata in the feature data, the n groups of feature operation units being connected according to association operation logic between the n pieces of feature subdata,
a group of feature operation units comprising a first operation subunit and a second operation subunit, and the first operation subunit and the second operation subunit being connected according to feature operation logic of the corresponding feature subdata, and
in the preset sequence, in any two adjacent groups of feature operation units, a time at which a first group of feature operation units starts the feature operation is at least one preset clock cycle earlier than a time at which a second group of feature operation units starts the feature operation.
